(19) United States
(12) Patent Application Publication
(10) Pub. No.: US 2026/0007952 A1
(43) Pub. Date: Jan. 8, 2026

(54) SongSavant

(71) Applicant: Kyle Robert Zeiler, Las Vegas, NV (US)

(72) Inventor: Kyle Robert Zeiler, Las Vegas, NV (US)

(21) Appl. No.: 18/766,348

(22) Filed: Jul. 8, 2024

(51) Int. Cl. A63F 9/18; A63F 13/80

(52) U.S. Cl. CPC A63F 9/183; A63F 13/80; A63F 2300/305

(57) ABSTRACT

SongSavant is an innovative mobile application that merges music knowledge with visual art through an engaging guessing game, driven by advanced AI technologies. Users start by selecting a music genre or choosing a random challenge. The AI then dynamically selects an artist and a curated set of their top songs within the chosen genre. As players progress through levels, the selection pool of songs expands, increasing the game's complexity. AI-generated illustrations representing the song titles are displayed in a carousel format, prompting players to guess the song and artist from multiple-choice options. The game adapts in difficulty, offering fewer hints and more choices as players advance, thus enhancing engagement through a unique integration of music and AI-generated art.

### BACKGROUND ON THE INVENTION

The digital era has seen a rise in mobile applications that merge entertainment with interactive elements. However, many music-based apps primarily focus on streaming or playing music without offering engaging, interactive experiences that challenge the user's knowledge in a stimulating way. Likewise, traditional trivia games often lack innovative integration with artistic and educational content.

SongSavant bridges this gap by combining music identification with visual art through an AI-powered guessing game. Users are presented with AI-generated illustrations based on song titles and are tasked with guessing the correct songs and artists from multiple-choice options. This novel approach enhances users' engagement with music and visual art simultaneously. To maintain a dynamic challenge, the application adjusts its difficulty by expanding the pool of songs the AI selects from as the user progresses through the levels.

Existing technologies typically rely on pre-stored databases for content delivery. In contrast, SongSavant leverages artificial intelligence (AI) models, such as ChatGPT and DALL-E, to dynamically generate song and artist selections and create corresponding illustrations in real-time. This flexibility allows for a unique and personalized gaming experience each time the application is used.

Additionally, SongSavant integrates an adaptive gameplay system with hints and increasing difficulty levels to keep user engagement high and continually challenge players.

### BRIEF SUMMARY OF THE INVENTION

SongSavant is an interactive mobile application designed to challenge users to identify songs and their respective artists based on dynamically generated illustrations. The application uses AI to select songs and artists in real-time and to create unique visual representations of song titles, which users then interpret to make their guesses. As players advance through levels, the AI selects from an expanding pool of top songs, increasing the game's complexity and challenge.

### Key Features of SongSavant Include:

Dynamic Song and Artist Selection with AI: Upon selecting a genre, AI algorithms dynamically choose an artist and a set of their top songs from the selected genre, with the set being selected from a larger pool of top songs as the user progresses to later levels.
Illustration Generation with AI: The chosen songs are then used to generate unique illustrations using AI technologies like DALL-E or other AI models that convert textual descriptions into artwork.
Interactive Gameplay: Users view the illustrations in a carousel format and are presented with multiple-choice options to guess the correct song and artist.
Hint System: Players are provided with a decreasing number of hints as they progress through levels. Hints can be used on either the band/artist guessing screen or the song title guessing screen, and are designed to guide the user without directly revealing the answer.
Adaptive Difficulty Levels: As players advance, the game increases in difficulty by providing fewer hints and more multiple-choice options, challenging users to rely more on their knowledge and deductive reasoning skills.
User-Friendly Interface: Designed for optimal use on mobile devices, the interface allows seamless navigation and interaction with the game elements.

SongSavant provides a novel and engaging way for users to deepen their connection with music through the lens of artistic interpretation, powered by AI technologies and adaptive gameplay features.

### BRIEF DESCRIPTION OF VIEWS OF THE DRAWING

FIG. 1: Start/Genre Screen

FIG. 2: Game Screen Band/Artist

FIG. 3: Hint Screen Band/Artist

FIG. 4: Game Screen Song Title

FIG. 5: Full Screen View Mode.

FIG. 6: Hint Screen Song Title

FIG. 7: Results/Score Screen

FIG. 8: Settings Screen.

FIG. 9: Help Screen

### DETAILED DESCRIPTION OF THE INVENTION

### User Interaction and Game Flow:

Users begin at the Start Screen where they can select their preferred music genre or choose a randomized challenge. The app displays several genre options, each leading to a different set of dynamically generated content.

Upon selecting a genre, AI algorithms dynamically select an artist and three of their top songs within the chosen genre. This selection is performed in real-time, based on AI's analysis of popular trends and artist profiles, without relying on a pre-stored database.

The user is then taken to the Game Screen, where a carousel of three illustrations is presented. Each illustration is generated using AI technologies like DALL-E or similar models to visually represent the song titles chosen by the AI. Users view each illustration and are prompted to guess the song and artist from multiple-choice options displayed below the carousel. The illustrations can be enlarged for better detail viewing.

### Adaptive Difficulty and Expanding Song Pool:

SongSavant's AI dynamically adjusts the game's difficulty by expanding the pool of top songs from which it selects as the user progresses. In the initial levels, the AI selects from a smaller pool of top songs. As the user advances to later levels, the AI expands this pool, drawing from a larger set of top songs by the selected artist. This ensures that the game remains challenging and engaging, with a wider variety of songs and increased complexity in the guessing game.

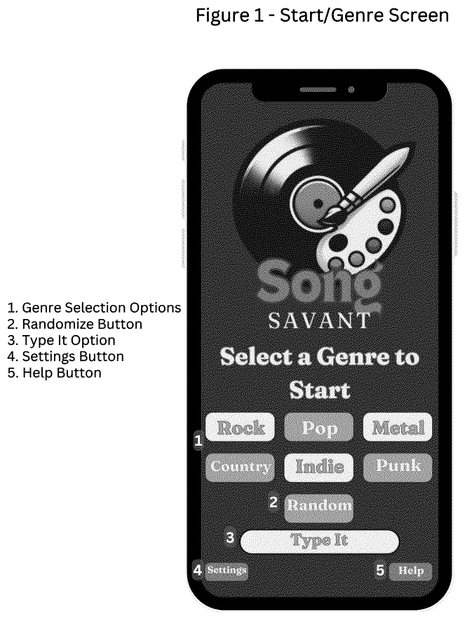

### Start/Genre Screen Interface (FIG. 1)

The Start Screen Interface is the initial point of interaction for users upon launching SongSavant. This screen allows users to choose their preferred music genre to start the game.
Title and Branding: The top of the screen prominently displays the SongSavant logo, a creative blend of a vinyl record and a paint palette, symbolizing the integration of music and visual art.
Genre Selection: Users are prompted to “Select a Genre to Start,” with options including Rock, Pop, Metal, Country, Indie, and Punk. Each genre is represented by a distinct, color-coded button to facilitate quick visual identification.
Random Option: The “Random” button allows the system to select a genre at random, adding variety to the gameplay.
“Type It” Feature: Positioned below the genre options, the “Type It” button lets users manually enter a specific genre, providing flexibility for users who have a particular genre in mind that is not listed among the predefined options.
Navigation Buttons: At the bottom of the screen, the “Settings” button offers access to the app's configuration options, while the “Help” button provides guidance on how to use the application.

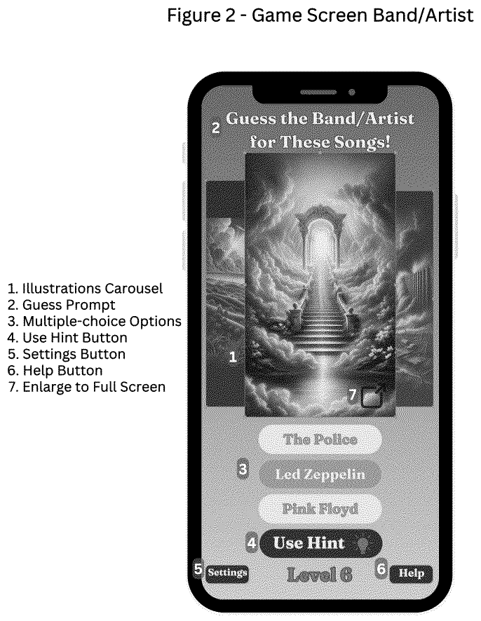

### Game Screen Interface for Band/Artist (FIG. 2)

The Game Screen Interface presents users with AI-generated illustrations in a carousel format. These illustrations are visual representations of the selected song titles.
Illustration Display: The screen displays three illustrations in a carousel that users can scroll through. Each illustration is dynamically generated by AI based on the song titles chosen for the session.
Multiple-Choice Options: Below each illustration, users are presented with multiple-choice options to guess the correct song title and artist.
Enlarge Option: Users can click on the illustrations to enlarge them for a closer view, which aids in making more accurate guesses.

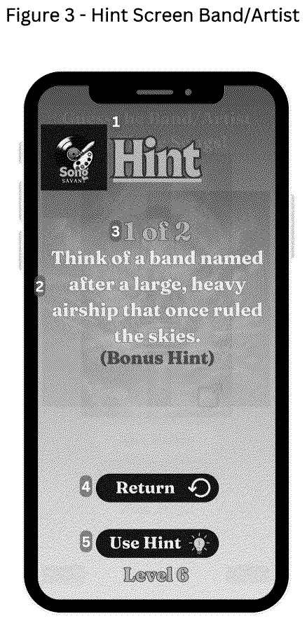

### Hint Screen for Band/Artist (FIG. 3)

When a user selects a hint during the game, the play screen fades, and the Hint Screen appears overlaying it. This screen provides contextual hints to help users make their guesses.
Hint Display: The hint is displayed in the middle of the screen, with an overlay indicating how many hints have been used.
Return to Game: Users can return to the game screen by clicking the “Return” button.

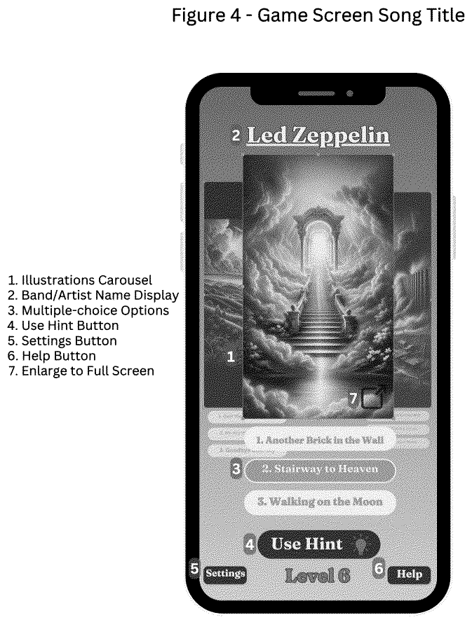

### Game Screen Interface for Song Title (FIG. 4)

After guessing the band/artist, users proceed to the song title guessing phase. The Game Screen for Song Title presents additional multiple-choice options under each illustration.
Illustration Display: The same carousel of illustrations is used, now prompting users to guess the song title.
Multiple-Choice Options: Options for the song title are displayed below each illustration.
Band/Artist Display: The correct band/artist name is now shown above the carousel.

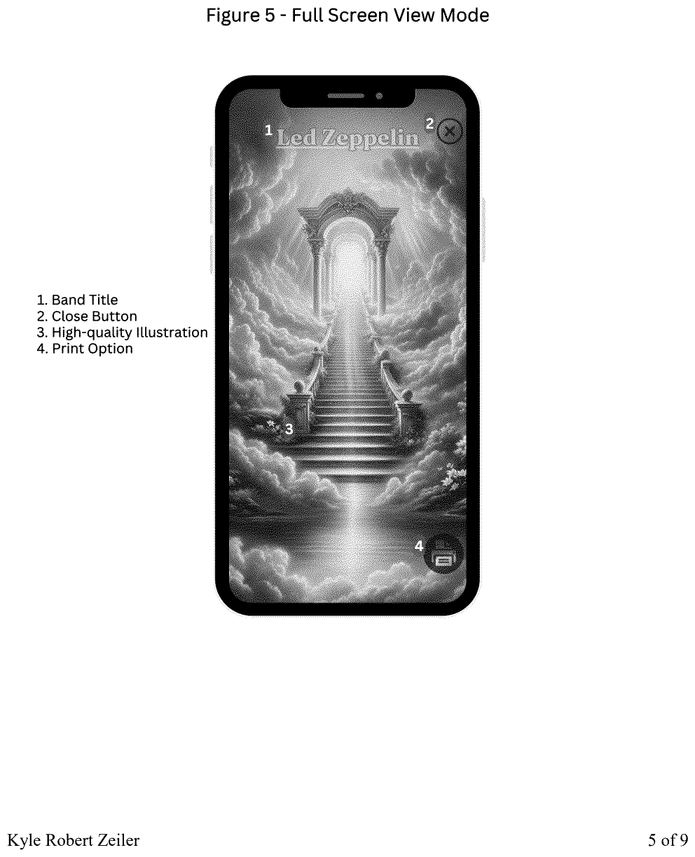

### Full-Screen View Mode (FIG. 5)

To enhance the gameplay experience, SongSavant includes a full-screen view mode. This feature allows users to enlarge the illustrations for a more detailed examination.
Enlarged View: Users can click on an illustration to view it in full screen, which helps them analyze the visual details closely.
Navigation Controls: The full-screen mode includes controls to navigate back to the game screen or move between illustrations.
Print Option: Users have the option to print the illustration from the full-screen view mode, providing a physical copy for further reference or enjoyment.

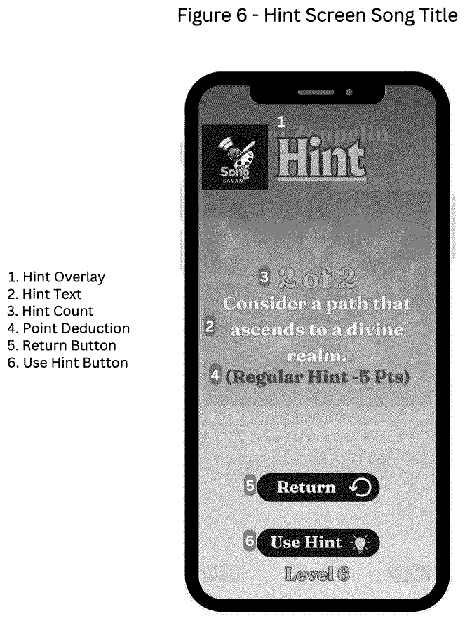

### Hint Screen for Song Title (FIG. 6)

Similar to the Band/Artist hint screen, the Song Title hint screen provides contextual hints to help users guess the song title.
Hint Display: The hint appears in the middle of the screen and indicates how many hints have been used and any point deductions for using hints.
Return to Game: Users can return to the game screen by clicking the “Return” button.

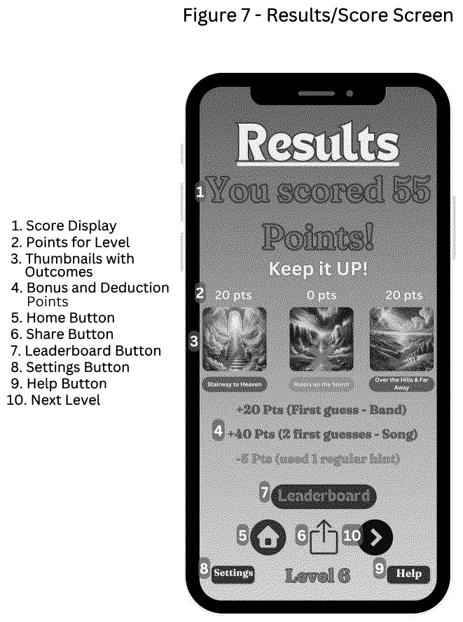

### Results/Score Screen (FIG. 7)

After completing a game session, the Score Screen displays the user's performance metrics, including the number of correct guesses and total points scored.
Performance Summary: The screen shows a detailed summary of the user's performance for the session, including the total score and feedback on each guess.
New Game and Sharing Options: Users can start a new game or share their results on social media from this screen.

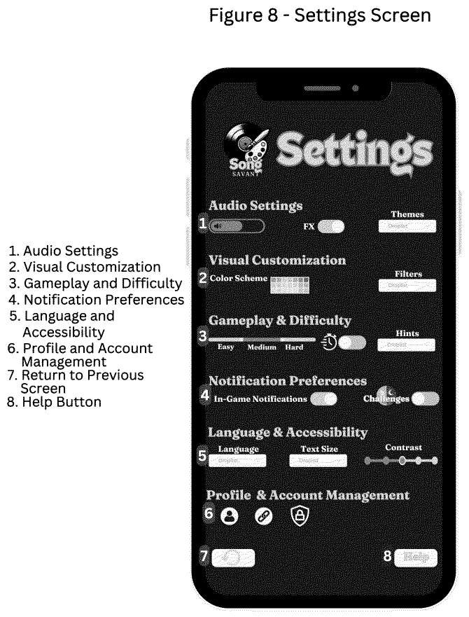

### Settings Screen Interface (FIG. 8)

The Settings Screen allows users to customize their gameplay experience. Users can adjust various options to tailor the game to their preferences.
Customization Options: Settings include adjustments for difficulty levels, timer settings, visual themes, and audio preferences.
User Interface Settings: Users can select different themes and colors to personalize the app's appearance.

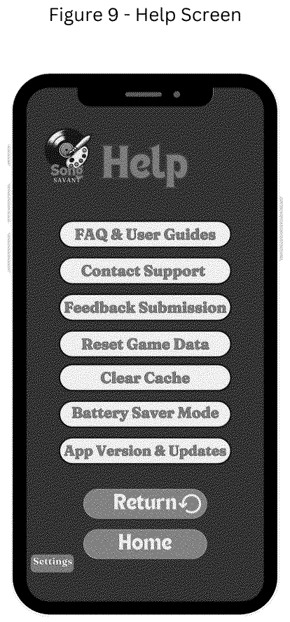

### Help Screen Interface (FIG. 9)

The Help Screen provides users with detailed instructions on how to use the app, navigate its features, and make the most out of the gameplay experience.
Instructions and Tips: The screen includes step-by-step guidance and tips for using the app effectively.
User Assistance: Provides assistance with understanding game mechanics and utilizing app features.

### Gameplay Mechanics

The difficulty in SongSavant progresses as players advance through the levels. This system is designed to gradually increase the challenge, making the game more engaging and testing the players' music knowledge and deductive skills. The structure of difficulty, hint usage, and scoring is as follows:

### Difficulty Levels

For each level, players are presented with multiple-choice options for both guessing the band/artist and the song titles based on the AI-generated illustrations. The hints available are cumulative across both guessing phases within each level. Additionally, “Bonus Hints” provide strategic advantages for managing hints across levels.

### Levels 1-5:

Multiple-Choice Options:
   Players have three options for guessing the band/artist.
   Players have three options for guessing each song title.
Hints:
   Three hints are available in total for each level.
   The first two hints are Bonus Hints and do not cost points.
   The third hint is a Regular Hint and deducts 5 points from the player's score.
   Hints are cumulative across both the band/artist and song title guessing phases. For example, if a player uses one hint during the band/artist phase, they will have two hints left for the song title phase.
Bonus Hints:
   Players can carry over unused Bonus Hints from one level to the next.
   If no hints are used during a level, players are rewarded with one additional Bonus Hint for the next level.
   A Bonus Hint can be used in place of a Regular Hint that would normally deduct points, preserving the player's score.
Penalty for Incorrect Guesses:
   If a player fails to guess the band/artist within two guesses, any remaining Bonus Hints for the current level become Regular Hints, incurring point deductions if used.

### Levels 6-10:

Multiple-Choice Options:
   Players have three options for guessing the band/artist.
   Players have three options for guessing each song title.
Hints:
   Two hints are available in total for each level.
   The first hint is a Bonus Hint and does not cost points.
   The second hint is a Regular Hint and deducts 5 points from the player's score.
   Hints are cumulative across both the band/artist and song title guessing phases. For example, if a player uses one hint during the band/artist phase, they will have one hint left for the song title phase.
Bonus Hints:
   Players can carry over unused Bonus Hints from one level to the next.
   If no hints are used during a level, players are rewarded with one additional Bonus Hint for the next level.
   Bonus Hints can be used to offset point deductions.
Penalty for Incorrect Guesses:
   If a player fails to guess the band/artist within two guesses, any remaining Bonus Hints for the current level become Regular Hints, incurring point deductions if used.

### Levels 11-15:

Multiple-Choice Options:
   Players have four options for guessing the band/artist.
   Players have four options for guessing each song title.
Hints:
   Two hints are available in total for each level.
   Each hint used deducts 5 points from the player's score.
   Hints are cumulative across both the band/artist and song title guessing phases. For example, if a player uses one hint during the band/artist phase, they will have one hint left for the song title phase.
Bonus Hints:
   Players can carry over unused Bonus Hints from one level to the next.
   If no hints are used during a level, players receive one additional Bonus Hint for the next level.
   Bonus Hints can be used to avoid point deductions.
Penalty for Incorrect Guesses:
   If a player fails to guess the band/artist within two guesses, any remaining Bonus Hints for the current level become Regular Hints, incurring point deductions if used.

### Levels 16-20:

Multiple-Choice Options:
   Players have four options for guessing the band/artist.
   Players have four options for guessing each song title.
Hints:
   One hint is available in total for each level.
   The hint deducts 10 points from the player's score.
   The hint is cumulative across both the band/artist and song title guessing phases. For example, if a player uses the hint during the band/artist phase, no hints remain for the song title phase.
Bonus Hints:
   Players can carry over unused Bonus Hints from one level to the next.
   If no hints are used during a level, players are rewarded with one Bonus Hint for the next level.
   The Bonus Hint can be used to avoid the 10-point deduction.
Penalty for Incorrect Guesses:
   If a player fails to guess the band/artist within two guesses, any remaining Bonus Hints for the current level become Regular Hints, incurring point deductions if used.

### Summary of Difficulty Levels:

### Levels 1-5:

Options:
   Band/Artist: Three options
   Song Title: Three options
Hints:
   Three hints in total for each level.
   The first two hints are Bonus Hints and do not cost points.
   The third hint is a Regular Hint and deducts 5 points.
   Unused Bonus Hints can be carried over to the next level.
   Bonus Hints become Regular Hints (costing points) if the band/artist is not guessed within two attempts.

### Levels 6-10:

Options:
   Band/Artist: Three options
   Song Title: Three options
Hints:
   Two hints in total for each level.
   The first hint is a Bonus Hint and does not cost points.
   The second hint is a Regular Hint and deducts 5 points.
   Bonus Hints can be used to offset point deductions.
   Players earn an additional Bonus Hint if no hints are used during a level.
   Bonus Hints become Regular Hints (costing points) if the band/artist is not guessed within two attempts.

### Levels 11-15:

Options:
   Band/Artist: Four options
   Song Title: Four options
Hints:
   Two hints in total for each level.
   Each hint used deducts 5 points.
   Bonus Hints can be carried over and used to avoid point deductions.
   Players gain a Bonus Hint if no hints are used during a level.
   Bonus Hints become Regular Hints (costing points) if the band/artist is not guessed within two attempts.

### Levels 16-20:

Options:
   Band/Artist: Four options
   Song Title: Four options
Hints:
   One hint in total for each level.
   Using the hint deducts 10 points.
   Bonus Hints can be used to avoid the 10-point deduction.
   Players earn a Bonus Hint if no hints are used during a level.
   Bonus Hints become Regular Hints (costing points) if the band/artist is not guessed within two attempts.

This system ensures that players face a steadily increasing challenge while rewarding strategic play. The introduction of penalties for incorrect guesses provides a counterbalance to the advantage of Bonus Hints, maintaining a challenging and engaging gameplay experience.

### Scoring System

The scoring system in SongSavant is designed to reward correct guesses, penalize reliance on hints, and provide clear incentives for strategic gameplay. Here's how the scoring works across different phases of the game:

### Band/Artist Guessing Phase:

Multiple-Choice Options: Players are presented with three or four options depending on the level.
Guess Attempts: Players have two attempts to guess the correct band or artist.
   First Guess: If the first guess is correct, the player earns 20 points.
   Second Guess: If the first guess is incorrect, the player can make a second guess.
      Second Guess Correct: The player earns 10 points for a correct second guess.
      Second Guess Incorrect: If the second guess is also incorrect, the correct band/artist is revealed, and the player earns zero points for this specific band/artist.
   Penalty for Incorrect Guesses: If the player fails to guess the band/artist within two guesses, any remaining Bonus Hints for the current level become Regular Hints. This means they will incur point deductions if used in the subsequent song title guessing phase.
Transition to Song Title Phase: Regardless of the outcome for each band/artist guess, the player moves to the song title guessing phase for the corresponding song title(s).

### Song Title Guessing Phase:

Multiple-Choice Options: Players are presented with three or four options depending on the level.
Guess Attempts: Players have two attempts to guess the correct song title.
   First Guess: If the first guess is correct, the player earns 20 points.
   Second Guess: If the first guess is incorrect, the player can make a second guess.
      Second Guess Correct: The player earns 10 points for a correct second guess.
      Second Guess Incorrect: If the second guess is also incorrect, the correct song title is revealed, and the player earns zero points for this specific song title.

### Hint Usage:

Hints Available: Players can use hints to assist with their guesses. The number of hints available and their point cost varies by level.
   Bonus Hints:
      These hints do not cost points.
      Availability by Level:
         Levels 1-5: Two Bonus Hints available per level.
         Levels 6-10: One Bonus Hint available per level.
         Levels 11-20: No initial Bonus Hints available, but they can be carried over from previous levels.
      Carrying Over Bonus Hints:
         If no hints are used during a level, the player is rewarded with one additional Bonus Hint for the next level.
         Any unused Bonus Hints from the current level carry over to the next level as Bonus Hints.
   Regular Hints:
      These hints cost points to use and do not carry over to the next level if unused.
      Availability and Cost by Level:
         Levels 1-5: One Regular Hint available. This hint costs 5 points.
         Levels 6-10: One Regular Hint available. This hint costs 5 points.
         Levels 11-15: Two Regular Hints available. Each hint costs 5 points.
         Levels 16-20: One Regular Hint available per level. This hint costs
Conversion of Bonus Hints:
   If a player fails to guess the band/artist within two guesses, any remaining Bonus Hints for the current level become Regular Hints, incurring point deductions if used in the song title phase.
End of Game Bonus:
   At the end of the game, each unused Bonus Hint is worth 5 points and is added to the player's total score.

### Speed Bonuses:

When the timer is enabled in the settings, players can earn additional points for quick, correct guesses:
   Band/Artist Guessing Phase: If the player correctly guesses the band/artist within the 30-second timer on the first attempt, they receive an additional 20 points.
   Song Title Guessing Phase: If the player correctly guesses each song title within the 30-second timer on the first attempt, they receive an additional 20 points per song title.

### Perfect Level Bonus:

If a player guesses the band/artist and all song titles correctly on the first attempt without using any hints, they receive an additional 25 points for that level. This bonus encourages players to aim for perfect accuracy and efficiency. The player also earns a Bonus Hint for the next level, as no hints were used.

### Total Score Calculation:

Points Earned: The total score is the sum of points earned from correct guesses for both band/artist and song titles.
Deductions: Points are deducted based on the usage of Regular Hints.
Speed Bonuses: Additional points are added for quick, correct guesses when the timer is enabled.
Unused Bonus Hints: At the end of the game, each unused Bonus Hint adds 5 points to the player's total score.
Perfect Level Bonus: 25 points are added for each level where the player guesses everything correctly on the first try without using hints. This is in addition to earning a Bonus Hint for the next level.
Net Score: The final score for each game session is the net of points earned from correct guesses, deductions for Regular Hint usage, speed bonuses, and points from unused Bonus Hints.
Score Display: At the end of each session, the total score is displayed, along with a breakdown of performance and options to start a new game or share results.

### Technical Implementation

The “Technical Implementation” section provides a comprehensive overview of the advanced AI-driven processes and system architecture that underpin SongSavant. This section elaborates on the unique algorithms that dynamically select music content and generate metaphorical illustrations while ensuring genre-appropriate options and adaptive gameplay.

### System Architecture

SongSavant employs a client-server model that integrates sophisticated AI technologies, allowing for dynamic and interactive user experiences.

### Client-Side Application:

User Interface: The mobile application where users interact with the game, handling inputs and displaying AI-generated content.
Cross-Platform Compatibility: Built using frameworks like Flutter or React Native, the application supports iOS and Android, ensuring broad device compatibility.

### Server-Side Infrastructure:

AI Models and Cloud Services: Hosted on cloud platforms (AWS, Google Cloud, Azure), these include natural language processing (e.g., ChatGPT) and image generation (e.g., DALL-E) models for scalable and efficient processing.
Data Management: Securely manages user sessions, game states, and necessary data storage, supporting real-time dynamic content generation.

### Algorithmic Processes

SongSavant's innovative algorithms are the core of its functionality, enabling dynamic music selection, illustration generation, and adaptive gameplay. These algorithms ensure that the game delivers unique and engaging content every time.

1. Genre and Artist Selection Algorithm: The system begins by accurately identifying the genre based on user input and proceeds to select a band/artist and songs that fit seamlessly within that genre.
User Input Processing: Handles genre input (selected, random, or typed).
Genre Analysis: Uses NLP to understand the genre's characteristics and trends.
Band/Artist Selection: AI selects a prominent band/artist relevant to the genre based on popularity metrics and relevance.
Song Selection: AI identifies top songs by the selected band/artist, focusing on chart performance and cultural impact. For levels 1-10, the selection is from the top three songs. For levels 11 and above, the selection expands to include the top 10 songs of the band/artist.
   Continuity Management: To maintain variety and challenge throughout a playthrough:
The AI keeps track of previously selected bands/artists and song titles within the current game session.
The algorithm ensures that the same band/artist and their top songs are not selected again within the same playthrough, even if the genre is re-selected later.

### Example Pseudocode for Genre and Artist Selection:

```
def select_artist_and_songs(genre_input, used_artists):
  genre = analyze_genre(genre_input) # Analyze genre characteristics
  artist = choose_unique_artist(genre, used_artists) # Select a new artist not used in the current
session
  top_songs = get_top_songs(artist, level) # Retrieve top songs based on current level
  return artist, top_songs
def choose_unique_artist(genre, used_artists):
  # Select an artist relevant to the genre that hasn't been used yet in the session
  available_artists = fetch_genre_artists(genre) − used_artists
  return select_from_available(available_artists)
def get_top_songs(artist, level):
  # Retrieve top songs based on the level
  if level <= 10:
    return fetch_top_songs(artist, top_n=3) # Top 3 songs for levels 1-10
  else:
    return fetch_top_songs(artist, top_n=10) # Top 10 songs for levels 11 and above
```

### Innovation and Novelty:

Dynamic Selection: Unlike traditional databases, this algorithm dynamically selects artists and songs in real-time, adapting to user input and genre trends.
Genre Relevance: Ensures that all choices are genre-appropriate, enhancing the gameplay's thematic consistency.
Continuity Management: Guarantees that the same band/artist and songs are not repeated within a single game session, maintaining variety and challenge.
   2. Multiple-Choice Options Algorithm: Ensures that both correct and incorrect options are genre-aligned, enhancing gameplay accuracy.
Band/Artist Phase: For the band/artist guessing phase, the AI provides three or four options based on the level:
   Correct Option: The selected band/artist from the genre.
   Incorrect Options: Two or three other bands/artists that are also relevant to the chosen genre.
Song Title Phase: For the song title guessing phase, under each illustration, the AI provides three or four options:
   Correct Option: The correct song title from the selected band/artist.
   Incorrect Options: Two or three other song titles that fit within the selected genre, but they do not have to be from the bands/artists provided in the previous phase.

### Example Pseudocode for Multiple-Choice Options:

```
def generate_multiple_choice_options(correct_option, genre, phase):
  if phase == “band_artist”:
    incorrect_options = get_incorrect_artists(genre, correct_option, count=2 if level <= 10 else
3)
  elif phase == “song_title”:
    incorrect_options = get_incorrect_songs(genre, correct_option, count=2 if level <= 10 else
3)
  options = shuffle([correct_option] + incorrect_options)
  return options
def get_incorrect_artists(genre, correct_artist, count):
  # Fetch incorrect artists within the same genre
  incorrect_artists = fetch_genre_artists(genre) − {correct_artist}
  return sample(incorrect_artists, count)
def get_incorrect_songs(genre, correct_song, count):
  # Fetch incorrect songs within the same genre
  incorrect_songs = fetch_genre_songs(genre) − {correct_song}
  return sample(incorrect_songs, count)
```

### Innovation and Novelty:

Flawless Genre Alignment: The algorithm ensures all options (correct and incorrect) align with the selected genre, maintaining thematic consistency.
Adaptive Option Generation: Adapts to the level, adjusting the number of options to increase difficulty as players progress.
   3. Illustration Generation Algorithm: This core process involves transforming song titles into detailed and imaginative visual representations. The AI creatively interprets the themes and emotions of song titles to produce fantastical and metaphorical illustrations.
Descriptive Text Generation: Using NLP models like ChatGPT, the AI generates rich, metaphorical descriptions based on the song titles. These descriptions capture the essence, themes, and emotions embedded in the song titles.
Image Generation: These descriptive texts are then input into an image generation model like DALL-E, which produces unique illustrations that visually represent the metaphorical and fantastical elements of the song titles.
Dynamic Creation: This process is performed each time a game session starts, ensuring that each gameplay session is unique and offers fresh, captivating illustrations.

### Example Pseudocode for Illustration Generation:

```
def generate_illustrations(songs):
  illustrations = [ ]
  for song in songs:
    description = generate_description(song) # Generate descriptive text
    illustration = create_image(description) # Create image from description
    illustrations.append(illustration)
  return illustrations
def generate_description(song_title):
  # Use NLP to generate a detailed, metaphorical description
  description = “A vivid scene depicting {song_title}, filled with surreal elements representing
{key_themes}.”
  return description.format(song_title=song_title, key_themes=analyze_themes(song_title))
def create_image(description):
  # Use AI model to generate an image based on the description
  return generated_image
```

### Innovation and Novelty:

Creative Interpretation: AI generates metaphorical and fantastical illustrations, going beyond literal depictions to create engaging and imaginative visuals.
Real-Time Generation: Illustrations are dynamically created for each game session, ensuring a unique and fresh experience every time.
   4. Adaptive Gameplay Algorithm: Adjusts the difficulty and hint availability based on user progress, maintaining engagement and challenge.
Hint Types:
   Bonus Hints: These hints do not cost points and can be carried over to subsequent levels if not used. They are earned by conserving hints during a level or by not using any Regular Hints.
   Regular Hints: These hints cost points to use. The cost increases as the player advances through levels.
Hint Management:
   Hint Carryover: Unused Bonus Hints from one level carry over to the next level as Bonus Hints.
   Hint Conversion: If a player fails to guess the band/artist within two guesses, any remaining Bonus Hints for the current level become Regular Hints, incurring point deductions if used.
   Dynamic Availability: The AI dynamically adjusts the number and cost of hints based on the player's progress and current level.
Difficulty Scaling: As players advance, the AI increases the complexity by adjusting the number of multiple-choice options and managing the cost of hints.
Real-Time Feedback: Provides immediate feedback on scores and game state, keeping players informed and engaged.

### Example Pseudocode for Adaptive Gameplay and Hint Management:

```
def adjust_hints_and_difficulty(level, user_progress, used_hints):
  hints = determine_hints(level, user_progress, used_hints) # Adjust hints based on level and
progress
  difficulty = scale_difficulty(level) # Scale multiple-choice complexity
  return hints, difficulty
def determine_hints(level, user_progress, used_hints):
  # Decide on the number and type of hints to offer
  if level <= 5:
    return {“bonus_hints”: 2 − used_hints, “regular_hints”: 1}
  elif level <= 10:
    return {“bonus_hints”: 1 − used_hints, “regular_hints”: 1}
  elif level <= 15:
    return {“regular_hints”: 2 − used_hints}
  else:
    return {“regular_hints”: 1}
def scale_difficulty(level):
  # Increase the number of multiple-choice options as the level increases
  if level <= 10:
    return 3 # Three options
  else:
    return 4 # Four options
def convert_bonus_to_regular_hint(used_hints, bonus_hints):
  # Convert remaining bonus hints to regular hints if the band/artist is not guessed within two
attempts
  if used_hints >= 2:
    return {“regular_hints”: bonus_hints, “bonus_hints”: 0}
  return {“regular_hints”: 0, “bonus_hints”: bonus_hints}
```

### Innovation and Novelty:

Dynamic Hint Management: AI dynamically adjusts hint availability and cost based on player progress and level, providing a strategic layer to the gameplay.
Real-Time Adaptation: Ensures immediate response to user actions, maintaining fluid and engaging gameplay.
   5. Real-Time Integration: Ensures seamless interaction between client and server, supporting smooth gameplay and timely updates.
Client-Server Communication: Handles data requests and responses between the mobile application and the server, facilitating real-time updates and content delivery.
Data Flow Management: Processes user inputs and game state data on the server, returning necessary updates to the client efficiently.
Session Continuity: Maintains continuous user sessions and tracks progress, ensuring a cohesive and uninterrupted gameplay experience.

### Detailed Algorithm Steps:

```
# Client requests new game data
client_request = {
  “action”: “start_game”,
  “genre”: selected_genre,
  “user_id”: user_id}
# Server processes the request and generates game content
server_response = process_game_request(client_request)
# Client receives and displays the generated content
display_game_content(server_response)
```

### SUMMARY

The “Technical Implementation” section of SongSavant details how advanced AI-driven processes and system architecture underpin the application's unique functionality. Key innovations include:
1. Dynamic Genre and Artist Selection: AI algorithms that accurately identify user-selected genres and dynamically select prominent bands/artists and their top songs, adapting to user input and maintaining genre relevance. This ensures a fresh and varied gameplay experience without repetition within a single playthrough.
2. Multiple-Choice Options Generation: The AI provides genre-aligned multiple-choice options for both band/artist and song title guessing phases. Correct options correspond with the selected artist and their top songs, while incorrect options fit the genre, ensuring thematic consistency.
3. Illustration Generation: Utilizing AI models like ChatGPT and DALL-E, SongSavant creates rich, metaphorical illustrations based on song titles. This process captures the essence and themes of the music, transforming it into engaging and imaginative visuals.
4. Adaptive Gameplay Mechanics: The AI dynamically adjusts the game's difficulty and manages hint availability, balancing Bonus Hints and Regular Hints to challenge players while providing strategic support. As the game progresses, the complexity increases, with higher levels expanding the song selection and adjusting hint costs.
5. Real-Time Integration: The seamless interaction between the client application and server supports smooth, real-time gameplay. This includes handling data requests, generating game content, and maintaining continuous user sessions for a cohesive gaming experience.
6. Continuity Management: The system ensures no repetition of the same band/artist or song within a playthrough, even if the genre is re-selected. This keeps the gameplay fresh and prevents redundancy.

This comprehensive integration of AI technologies and real-time data processing forms the foundation of SongSavant, making it a unique and innovative interactive music and art game. The system's ability to deliver dynamic, genre-appropriate content and manage gameplay complexities highlights its novelty and technical sophistication.

1. A method for generating interactive illustrations based on song titles, comprising:
Receiving a selection of a music genre or randomized challenge from a user.
Using AI to dynamically select an artist and a set of their top songs within the chosen genre, with the set being selected from a larger pool of top songs as the user progresses to later levels.
Generating visual illustrations corresponding to the selected song titles using AI technologies, such as DALL-E or similar models.
Displaying the AI-generated illustrations in a carousel format on a user interface.
Providing multiple-choice options for the user to guess the song and artist based on each illustration.

2. The method of claim 1, further comprising:
Providing hints related to the band/artist or the song title, with the number of hints decreasing as the user progresses through the levels.

3. The method of claim 1, further comprising:
Enlarging illustrations for detailed viewing upon user request.
Providing immediate feedback and scoring based on the user's guesses.

4. The method of claim 1, wherein:
The AI analyzes keywords and themes from the song titles to generate the visual illustrations.

5. The method of claim 1, wherein:
The user interface includes a start screen for genre selection, a game screen for viewing AI-generated illustrations and making guesses, and a score screen for displaying user performance.

6. The method of claim 1, further comprising:
Increasing the number of multiple-choice options as the user progresses, thereby increasing the difficulty level of the game.

7. A system for integrating music identification and visual art into an interactive game, comprising:
An AI model for dynamically selecting songs and artists based on user-selected genres, with the set of top songs being selected from a larger pool of songs as the user progresses to later levels.
An AI model for generating visual representations of the selected song titles.
A user interface displaying AI-generated illustrations and multiple-choice options for user interaction.
A hint mechanism for providing contextual hints to users based on the illustrations and the level of the game.
A difficulty adjustment mechanism that increases the challenge level by expanding the number of choices and reducing the number of hints as the user progresses.
A scoring mechanism for evaluating user guesses and providing feedback.
